(19) United States
(12) Patent Application Publication
(10) Pub. No.: US 2003/0043559 A1
(43) Pub. Date: Mar. 6, 2003

(54) Three-dimensional disposition structure of an electric board component

(75) Inventor: Canny Wang, Taipei (TW)

Correspondence Address: DOUGHERTY & TROXELL, SUITE 1404, 5205 LEESBURG PIKE, FALLS CHURCH, VA, 22041, US

(73) Assignee: PATEN Technology Coporation

(21) Appl. No.: 09/880,942

(22) Filed: Jun. 15, 2001

(51) Int. Cl. H01R 9/00

(52) U.S. Cl. 361/773; 361/760

(57) ABSTRACT

The three-dimensional disposition structure of an electric board component, comprising an electric board and several elements. The several elements includes several plane elements, which have at least one short connection leg, and several elevated elements, which have at least one long connection leg. Wherein, the plane element is welded onto the electric board and its bottom is close to the electric board, and the elevated element is welded onto the electric board and its bottom is above the plane element.

### 1. FIELD OF THE INVENTION

The present invention relates to, a three-dimensional disposition structure of an electric board component, especially to an electric board component on a same plane disposing structure upwardly.

### 2. BACKGROUND OF THE INVENTION

The design main stream for today's consuming electric products is all toward the lightness and smallness, so how to reduce the size of products becomes the endeavoring target for every manufacture and business firm.

The assembly structure of the prior electric board component is as shown in FIG. 1A, B and C.

Several elements 2 are arranged on the electric board 1 with plane type disposition, of which shortcoming is: in the plane type disposition, each element needs to occupy specific zone area in the electric board, if the electric board of function must be restrained within a small space, then plane disposition element type will waste lots of room.

### SUMMARY OF THE INVENTION

The main object of present invention is to provide an electric board component on a same plane disposing structure upwardly.

To reach aforesaid object, the three-dimensional disposition structure of an electric board component comprising an electric board and several elements.

The several elements includes several plane elements, which have at least one short connection leg, and several elevated elements, which have at least one long connection leg. Wherein, the plane element is welded onto the electric board and its bottom is close to the electric board, and the elevated element is welded onto the electric board and its bottom is above the plane element.

To clearly describe the operation principle of the three-dimensional disposition structure of the electric board component applied by the present invention, a detailed description in accordance with several drawings are presented as following:

### BRIEF DESCRIPTION OF THE DRAWINGS

FIG. 1A is a top view of the assembly structure of the prior electric board components.

FIG. 1B is a front view of the assembly structure of the prior electric board components.

FIG. 1C is a side view of the assembly structure of the prior electric board components.

FIG. 2A is a top view of the three-dimensional disposition structure of the electric board component.

FIG. 2B is a front view of the three-dimensional disposition structure of the electric board component.

FIG. 2C is a side view of the three-dimensional disposition structure of the electric board component.

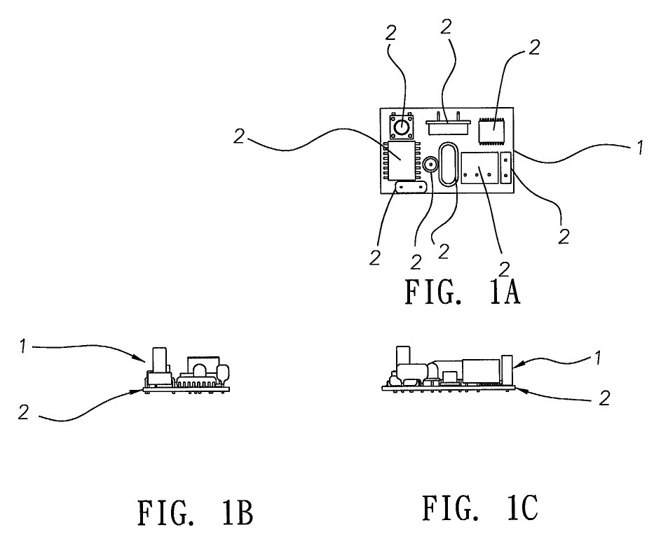

### DESCRIPTION OF THE PREFERRED EMBODIMENTS

Following is a preferable embodiment of the present invention.

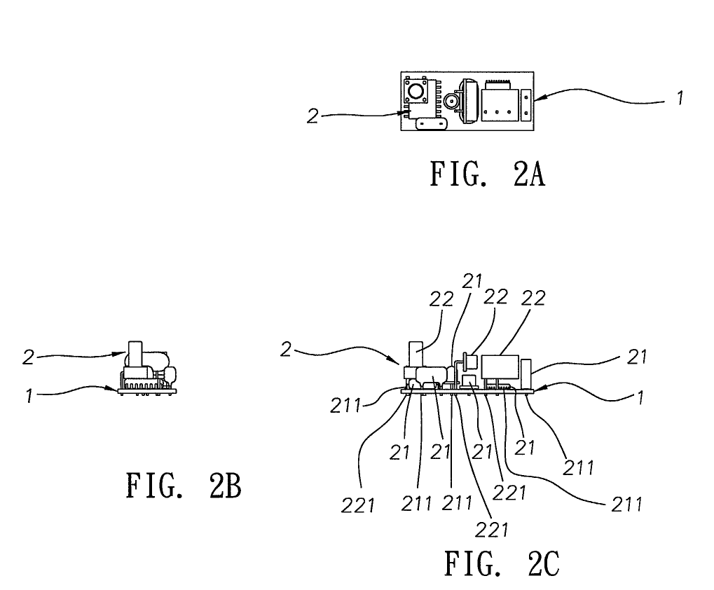

please refer to FIG. 2A, B, and C:

The three-dimensional disposition structure of an electric board component is comprised of an electric board 1 and several elements 2.

The several elements includes several plane elements 21, which have at least one short connection leg 211, and several elevated elements 22, which have at least one long connection leg 221. Wherein, the plane element 21 is welded onto the electric board 1 and its bottom is close to the electric board 1, and the elevated element 22 is welded onto the electric board 1 and its bottom is above the plane element 21.

Preferably, the long connection leg 221 of the elevated element 22 may decide its external form and length according to the actual altitude of the plane element 21. Namely, the length of the long connection leg 221 may be bent or cut in advance in accordance with the cooperation of the upper and lower positions of the plane element 21.

In summary, a three-dimensional disposition structure of an electric board component of the present invention disposes upwardly the needed elements by a three-dimensional disposition method to reduce the needed electric board area. After integrally assembling and matching with the needed outer shell, the volume of the product item may be reduced to minimum to be fulfilled with the lightness and smallness of trend of today's products.

What is claimed is:

1. A three-dimensional disposition structure of an electric board component, comprising:
an electric board;
several elements, comprising:
several plane elements, which have at least one short connection leg;
several elevated elements, which have at least one long connection leg; wherein, the plane element is welded onto the electric board and its bottom is close to the electric board, and the elevated element is welded onto the electric board and its bottom is above the plane element.

2. The three-dimensional disposition structure of an electric board component of the claim 1, wherein the long connection leg of the elevated element may decide its external form and length according to the actual altitude of the plane element.
